(19) United States
(12) Patent Application Publication
(10) Pub. No.: US 2002/0177908 A1
(43) Pub. Date: Nov. 28, 2002

(54) System and method for optimizing optical coupling in a cross connect switch

(76) Inventors: Sudarshan Bhat, San Marino, CA (US); Rob Dueck, Santa Ana, CA (US); Ratfi Garabedian, Monrovia, CA (US)

Correspondence Address: Wen Liu, LIU & LIU, LLP, Suite 1100, 811 West 7th Street, Los Angeles, CA, 90017, US

(21) Appl. No.: 10/102,601

(22) Filed: Mar. 19, 2002

Related U.S. Application Data
(60) Provisional application No. 60/277,046, filed on Mar. 18, 2001.
(60) Provisional application No. 60/277,049, filed on Mar. 18, 2001.
(60) Provisional application No. 60/277,057, filed on Mar. 18, 2001.

(51) Int. Cl. G05B 11/01

(52) U.S. Cl. 700/12

(57) ABSTRACT

The optical coupling in a cross connect switch is optimized through control of multi-variables using real time, real process data collection and true peak estimate function. Stored nominal values are used in determining initial peak value estimates, which are delivered to the real process variable elements as initial command values. Real time mapping and evaluation functions are performed on known or collected data sets from the real process and an estimate of the true optimal system values is made from the functional outputs. New optimized system command values are generated from the relevant peak estimate and delivered to the real process variable elements. The process can be iterated until optimization is achieved, or can be iterated indefinitely in order to constantly maintain a desired level of system optimization. Conversely, a trial-and-error searching technique may be used to determine the values of the variable elements required for optimization.

### TECHNICAL FIELD

This invention is generally related to the field of optimization methods for a technical system and/or process, particularly to the optimization by estimation of the peak values of a multi-dimensional problem, and more particularly to a novel control system and method for quickly finding and accurately maintaining peak optical coupling in an all optical cross-connect switch.

### BACKGROUND OF THE INVENTION

In an optical cross-connect switch system (such as the system disclosed in the concurrently filed, co-pending U.S. Provisional Application No. 60/277,047 (attorney docket no. 1017/233), entitled “Optical Cross-Connect Assembly”, filed Mar. 18, 2001 in the names of Dueck et. al, which is commonly assigned to Integrated Micromachines, Inc., the assignee of the present invention; which application is fully incorporated by reference herein), there are typically two opposing arrays of collimating optic elements and two opposing arrays of moveable micro-mirrors. The four array system is configured such that a light beam traveling through any input collimating optic on one of the collimating optic arrays may be routed to any output collimating optic on the opposing collimating optic array. This is generally accomplished by rotatably actuating one or more of the micro-mirrors in the system such that the beam is reflected off one mirror from each array to the desired output collimating optic. In such a system it is desirable to achieve peak optical coupling for each reflected beam such that signal power output is maximized, and optical loss across the switch is minimized. This system gives rise to a multivariable optimization problem, which is difficult to solve efficiently solely using known optimization methods.

In a given technical system, optimization is the process of adjusting one or more control variables to find the value(s) that correspond with a desired or most favorable outcome. One common method of optimizing one or more such variables is known as the “simplex” method of optimization. The simplex method is fundamentally a “trial-and-error” approach, and uses a step-by-step process of simultaneous variable modification, moving toward a desired output value with each iteration. The goal in a simplex or other optimization algorithm is to gain the optimal variable values in the least amount of time, or using the least number of process iterations.

Purely linear optimization problems are easily understandable; they can be easily represented in graphical form and solved with relatively few process iterations. Most “real world” optimization problems however, including the problem associated with an optical cross-connect switch, are non-linear and thus involve a complex application of simplex or other methods. As the level of inherent complexity in a given technical system increases, simplex and other sophisticated optimization algorithms prove inefficient when minimal process times are of critical importance. Additional factors that diminish the efficiency of simple optimization algorithms alone include imperfections in the technical system, deviations in system performance over time, external disturbances, and other difficult to control system variables. It would thus be desirable to develop an enhanced method and system for optimizing operational variables in such complex technical systems.

One prior art method of increasing optimization efficiency in a complex system involves delivering an operation variable to a control system model device wherein an output within a predetermined tolerable range representative of the real process is obtained; receiving an evaluation function thereby causing the control system model device to search for a first optimum control point; defining the first optimum point as an initial value and outputting a set value for the real process from a determined relevant region, with respect to the true optimal value, whose center is the initial value; and searching for a second optimum point within the relevant region using a trial-and-error algorithm. In essence, the time needed to search for the true optimal point using a trial-and-error method in a given technical system is reduced by defining a relevant search region from a first optimal point using a control system model device to mathematically model the real process. Such mathematical process models can yield a zone of probability for searching with a trial-and-error method, but may not yield the optimization times necessary in complex technical systems such as an optical cross-connect switch.

### SUMMARY OF THE INVENTION

It is therefore an object of this invention to provide a more efficient means of quickly determining the optimal values of a given multivariable technical system with a known desired output using a method of real time data collection and peak value estimation.

It is another object of the invention to provide a method for optimizing the optical coupling in an optical cross connect system.

It is a further object of this invention to provide a method for maintaining the optical coupling in an optical cross connect system at a desired value.

To accomplish these and other objectives, there is provided, in accordance with this invention, a method for optimizing variable elements in a given technical system comprising the steps of using stored or generated nominal real process values corresponding to routine system calibrations or data tables in the determination of an initial system command value; delivering initial system command values to corresponding real process variable elements for directing them to an initial peak estimate; introducing or using system deviations around predetermined relevant portions of the initial peak estimate to collect real time, real process data; using a real time data mapping device to compare and evaluate collected real time data, real process output data, and initial command values for estimation of true peak (optimum values); generating new system command values from estimated true peak and repeating the process iteratively until such time as optimal output is achieved. Alternatively, after estimation of true peak values, the simplex or other trial-and-error algorithm may be used to optimize the variable elements of the system.

According to the present invention, there is also provided an optimized real process control system comprising a global control device which stores and routes data and command values appropriately to and from the real process elements and the system optimization elements for facilitation of quick optimization times; a real time multi-data set mapping device for processing of stored, collected, and calculated data relating to the technical system; an evaluation function for determining true peak estimates from data maps; an optional optimization algorithm device that can be implemented to determine peak value(s); real process variable elements corresponding to the technical system for receipt of and response to command values; and a real time data collection device which senses, detects, or otherwise accurately determines or allows to be determined a present state of the real process at a given time and sends such data to the global control device.

Therefore, the optimum system command values (i.e. those that produce the desired output data) are quickly and accurately estimated while the real process variable elements change state, even in complex technical systems where the initial command values are well outside of an ideal range for traditional trial-and-error search methods. Upon completion of one process iteration, it is possible to have accurately determined the optimal system command values, which may be given as final system command values on the second process iteration. One may introduce a sequential trial-and-error search method once within a desired range of the optimal value, but in most cases such searching will not be necessary. It is also unnecessary in this present invention to create complex mathematical models of the real process to determine a tolerable search range for the trial-an-error optimization method. In fact, many performance critical complex technical systems would not be optimized quick enough with such a method, as there is still a need for multiple process iterations using a trial-and-error method.

Moreover, in a technical system where imperfections, external disturbances, and time or condition dependent deviations are difficult to control, model, or compensate for, real time, real process data collection and true peak estimation may be the only method sufficient to produce optimized results in an acceptable time. Using such a method it is unnecessary to employ trial-and-error search algorithms where sufficient real process data can be collected from system deviations around an initial peak estimate.

### BRIEF DESCRIPTION OF THE DRAWINGS

In the accompanying drawings:

FIG. 1 is a block diagram schematically representing an optimized process control system according to the present invention.

FIG. 2 is a process flowchart used to explain the mode of operation thereof.

FIG. 3 is a schematic diagram showing the mapping of a function for optimization, and transformation to anther function to facilitate estimation of the optimized point.

### DETAILED DESCRIPTION OF THE PREFERRED EMBODIMENT

This invention is described in the following description with reference to the drawings. While this invention is described in terms of the best mode for achieving this invention's objectives, it will be appreciated by those skilled in the art that variations may be accomplished in view of these teachings without deviating from the spirit or scope of the invention. This description is made for the purpose of illustrating the general principles of the invention and should not be taken in a limiting sense. The scope of the invention is best determined by reference to the appended claims.

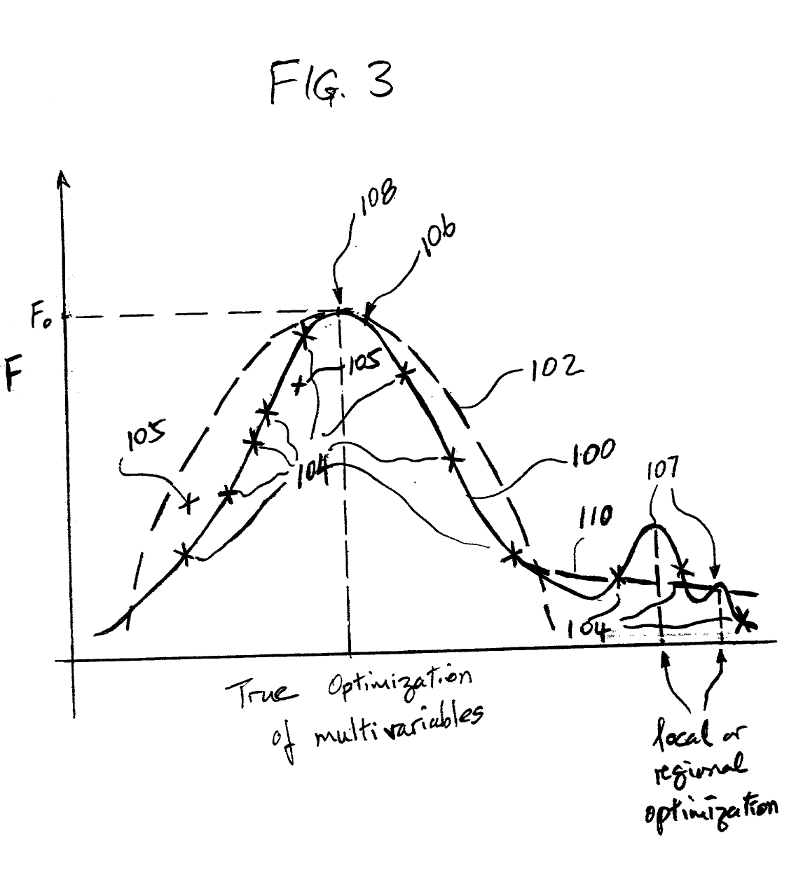

Referring to FIG. 3, the overall concept of the optimization scheme in accordance with the present invention involves real-time estimation of the actual or true global optimized value F₀ at 108 (as compared to a regional or local optimized values at 107) of a multivariable function F, based on real-time mapping 100 of a set of values of the function F obtained at data points 104 sampled about an initial target optimized value 106. The sampling of the data points 104 are carried out in real time, by introducing perturbations, excitations, or patterns to the function (at variable and/or random sampling rate, or at specific constant sampling rate), or by processing real time transient data when the function is being driven to the initial target optimized value 106. For example, for a technical system, the perturbations, excitations or patterns may be artificially introduced into the system as dither or orbit patterns, or may arise from the transient instability or oscillations inherent in the system. Based on the mapping, the actual global optimized value F₀ can be estimated by any one of a number of estimation schemes, such as interpolation and/or extrapolation schemes. In the alternate and/or in addition, the actual global optimized value may be determined by deploying additional fine optimization schemes to further fine tune the optimization estimated from the mapped values. In certain applications, it may be beneficial to transform the data set obtained for the function to be optimized to another function that would provide better resolution in estimation by interpolation, extrapolation or other schemes. For example, a data set 104 known to follow a substantially Gaussian distribution 100 may be transformed, using the least squares method, to a parabolic distribution 102 as illustrated in FIG. 3, to facilitate interpolations to determine the line of best fit. The Method of Least Squares produces a single equation (of a desired complexity/order) that best matches the supplied data points 104 in FIG. 3. While straight line interpolation will produce answers between observed points, the Method of Least Squares attempts to model the dynamic nature of data changes.

While most of the data points 104 are shown to lie on the curve 100, it is understood that some of the data points (exemplified at 105) could be off the curve 100, but the curve 100 may be nonetheless obtained by interpolation, extrapolation or other schemes to find the line of best fit through the data points (for example, the section of the curve 100 represented by dotted line 110 in the Gaussian plane). The interpolation of the data 104 along section 110 will eliminate erroneous local or regional optimization values.

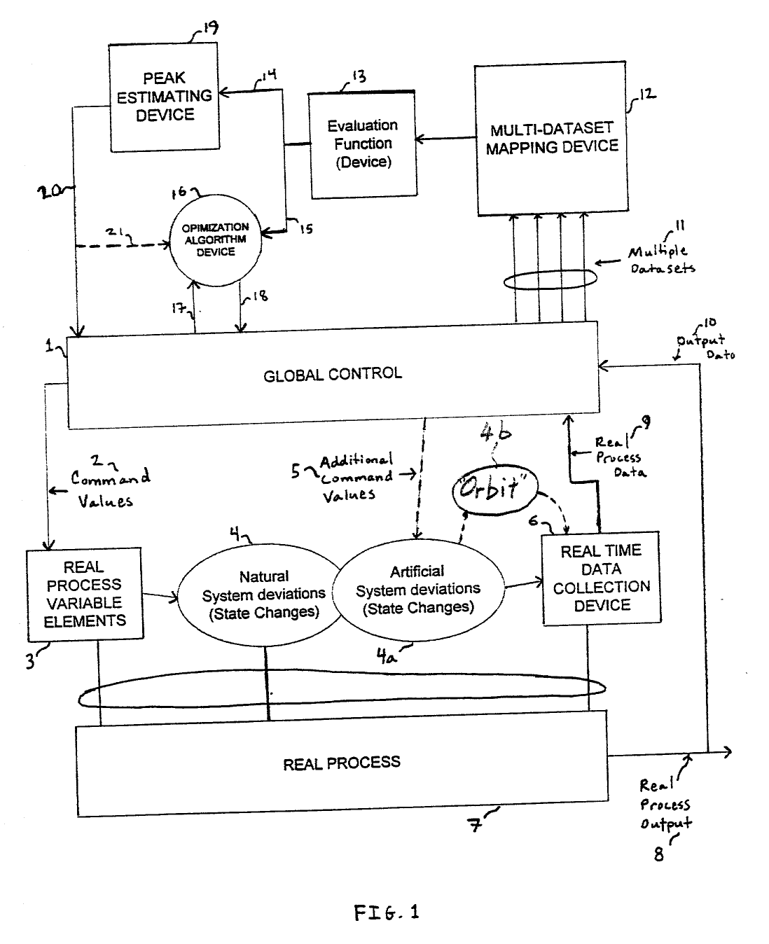

FIG. 1 is a schematic illustration of an optimized control system in accordance with the present invention which, using global control device 1 may send optimized command values 2 to the variable elements 3 of a real process 7 thus optimizing the real process output 8. More specifically, the system described in accordance with the present invention comprises a global control device 1 which includes a multi-dataset mapping device 12 for functionally operating on multiple datasets 11 specific to the given system; an evaluation function device 13 for evaluatively operating on mapped datasets, performing algorithms or routines; a peak estimating device 19 for operating on one or more data maps to generate relevant peak process estimates(s) 20; and an optimization algorithm device 16 for operating on two or more datasets in accordance with the simplex or other trial-and-error optimization algorithm, routine, or process; and a real process 7 which is any technical system wherein initial command values may be calculated, calibrated, ascertained or otherwise known to a degree sufficient to make an adequate estimate of the initial output peak values; system deviations during state changes naturally occur or may be artificially induced; and relevant data of such deviations may be collected for processing. The global control device operates on and interacts with the real process such that system optimization is accomplished in the least number of process iterations, with or without using simplex or other trial-and-error methods, for a given technical system and/or under a given set of parameters or circumstances. The concurrently filed, co-pending U.S. Provisional Application No. 60/277,057 (attorney docket no. 1017/226), entitled “Distributive Optical Switching Control System”, filed Mar. 18, 2001 in the names of Evans et. al, which is commonly assigned to Integrated Micromachines, Inc., the assignee of the present invention, describes in detail the nature and function of system components and elements, which may be used to practice the current invention. This application is fully incorporated by reference herein.

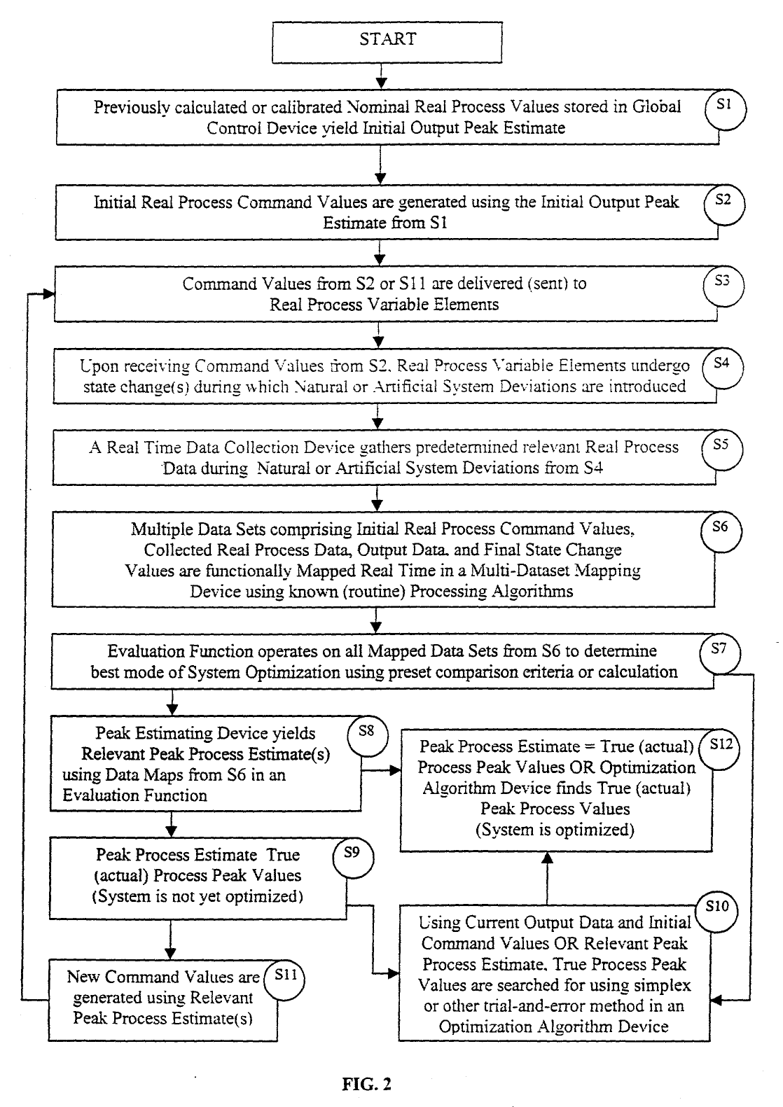

FIG. 2 is a flowchart wherein the method of optimization will be detailed by referencing the above described optimized control system. In this embodiment, the real process is a complex technical system whose output is difficult to optimize because of any variety of problems related to the physical, chemical, biological, or other characteristics intrinsic to or imposed on the system. It should be noted that particular features and elements in this invention, such as the real process variable elements, real time data collection of system deviations during state changes, and output data will differ widely from system to system, especially in systems across differing fields of study. It will also be appreciated that the invention is not especially limited to a certain complex technical system, but will nonetheless be described as applied to an optical cross-connect (OXC) system.

According to the present invention, the global control device is any computing or processing device able to simultaneously store, send, receive, perform operations on and functionally analyze system data components using given parameters, algorithms, codes, or instructions. The global control device in an OXC system stores nominal real process data values, which have been previously calculated mathematically (or analytically) or calibrated using known real process data calibration techniques. Such nominal data values either are themselves, or correspond to, an initial output peak estimate of the process or system for given sets of input parameters (Step 1). This can be accomplished with a standard data or value table stored in the memory of a global control device. The initial output peak estimate(s) are a good, or acceptable, approximation of the command values 2 necessary to optimize the system for a known or desired output. In the case of an OXC, the initial output peak estimates are the x and y positions of two opposing mirrors which yielded the last known optimal output (least optical loss) for a given set of coupling commands. Additionally, the initial output peak estimates may contain more command date or information data than simple positional or other rudimentary commands. For instance, in the case of an OXC, not only can x and y positions for two opposing sets of mirrors be sent, but estimates as to the time lapse necessary to reach a point substantially near enough the coupling peak may be sent as well, thus enabling the optimization process to become more efficient using these additional values. To further illustrate, as positional command values are sent to the opposing mirrors in an OXC, time lapse estimates (i.e. the calculated or estimated time it will take for each mirror to slew to the commanded initial output peak estimate value) may be sent to the optimization algorithm device (mail or local processors in the case of the OXC) to trigger initiation of the optimization process at a set time. It is possible to increase the overall system optimization time by sending such additional commands or values along with the initial peak value estimate. It is possible to generate nominal data values using the present invention by systematically applying the provided system and method to each set of system variable elements and storing all results. Once a complete set of nominal real process values are stored in the global control device, the system is prepared to optimize given input parameters. Such method would also work for additional values such as calculated or estimated time lapse data or other relevant system data which may be used to further hasten the optimization process. It may be advantageous to provide for a dynamically updated set of nominal real process values such that, as a technical system undergoes state changes, nominal real process values for each desired output are calibrated and re-calibrated in real time. Given this approach it is apparent that calibrated nominal real process values stored in the global control device may only remain “functional” for a short period of time (on the order of micro-seconds in some systems) for systems capable of rapid state changes and high data transfer speeds.

The global control device in an OXC will receive a coupling command, directing light from one input collimating lens to a different output collimating lens. Using the now stored nominal values, an initial command value is generated (Step 2). Command values are then sent to the variable elements in the real process (Step 3). Initial command values may be sent in whatever manner of signals representing the commands or instructions, which are compatible with control of the process variables in the given technical system. In the present case, initial command values are electrical signals (i.e. currents or voltages) sent to the actuators for the corresponding mirror axes to effectuate a mirror displacement (Step 3) The actuation of the mirrors may follow the system disclosed in the concurrently filed, co-pending U.S. Provisional Application No. 60/277,135 (attorney docket no. 1017/204), entitled “Lorentz Motor And Implementations In MEMS-Based Optical Switches”, filed Mar. 18, 2001 in the names of Temesvary et. al, which is commonly assigned to Integrated Micromachines, Inc., the assignee of the present invention. This application is fully incorporated by reference herein.

System deviations or other appropriate state changes should then be present in the system according to the present invention. Deviations or state changes about the initial peak estimate are most useful, and will yield data maps encompassing the desired real process optimal output. To put it differently, deviations outside known, discovered, or assumed relevant state change regions will not be useful to the present invention. In an OXC, the x and y positions of each opposing mirror are the real process variable elements 3 in FIG. 1. Once angular mirror displacements are in process, natural system deviations in the form of mechanical oscillations 4 occur as the system settles (i.e. mirror vibrations, oscillation, or perturbations about their final rest position constitute natural system deviations for purposes of this invention). Other technical systems may undergo different natural system deviations, though not necessarily oscillatory or tied in any way to the settling or transient nature of the system. Still other technical systems may undergo little or no deviation during a state change, in which case it will be necessary to artificially induce deviations about the initial peak estimate according to the present invention. It may also be necessary or desirable according to this invention to artificially induce further deviations in systems where such deviations are naturally occurring so that additional, or more relevant data may be collected. It may further be desirable to introduce non-random motion in the system (as opposed to deviations) such that additional functionality is achieved while relevant output data is collected. In the case of an OXC system, it will be advantageous to provide for “orbit” patterns of the mirror elements about an optimized peak coupling value (i.e. the value where least optical loss is present for a coupling) such that a constant attenuated (e.g. any value less than the peak coupling value) output is achieved while still enabling real time data collection due to the constant induced state changes. In such cases where artificial deviations or controlled motions are induced, the global control, using preset known algorithms or operations on the initial peak estimate, may send additional command values to the variable elements in the real process such that necessary deviations are produced (Step 4).

In another embodiment of this invention, the global control device initiates such deviations in the real process, but is not the means for effectuating them. In this case, a control signal from the global control device initiates the dither or excitation in the real process, and appropriate dithering or excitation means in or on the real process effectuates the desired system deviations. In an OXC, such deviations are effectuated by a control system including an onboard ASIC within each mirror subsystem as disclosed in the concurrently filed, co-pending U.S. Provisional Application No. 60/277,057 (attorney docket no. 1017/226), entitled “Distributive Optical Switching Control System”, filed Mar. 18, 2001 in the names of Evans et. al, which is commonly assigned to Integrated Micromachines, Inc., the assignee of the present invention. This application is fully incorporated by reference herein. Such onboard means of effectuating a dither or excitation pattern is advantageous in systems where bandwidth (i.e. ability of the system to transmit a given quantity of data at a given rate) is limited. It may also be advantageous to implement a scaled or incremental deviation scheme. In such a scheme, dither or excitation amounts would not be predetermined or random, but scaled in response to a given functional output, or known state of the system. For example, if analysis of certain functional output determined that the system was very near it's optimal point, a command signal initiating a small deviation would be sent. Conversely, a determination that the system was far from its optimal point would prompt initiation of large deviations in the system. In this way system deviations, which may be undesirable in certain systems outside of their application in this present invention, may be kept to a minimum. It will be appreciated by those skilled in the art that many ways of effectuating minimal amounts of deviations necessary to practice this invention will be possible for a given technical system.

Once relevant deviations are introduced in the system, whether naturally or artificially, real time data must be collected while such deviations are in process (Step 5). This is accomplished by a real time data collection device, such as a sensor, receiver, contact, pickup, or other data collection element. Some of the requirements for such a data collection device are that it can accurately collect present state data concerning the variable elements, and that it's collection resolution (i.e. number of data points it can collect during a given period of time) be at least great enough to collect a sufficient number (generally, the number of variable system elements+1) of points in the time elapsed during relevant portions of system state changes to start the simplex or other trial-and-error optimization algorithm. One would choose data collection device(s) of the greatest accuracy and highest collection resolution so that the number of data points collected during the relevant portions of a state change would be maximized. In addition to maximizing number of collected data points, it is desirable to collect a rich set of data points such that sampling is, as much as possible in a given technical system, an accurate representation or mapping of the distribution throughout the entire relevant region. In an OXC, the data collection devices are position sensors located below each of the mirror surfaces. Examples of position sensors are disclosed in the concurrently filed, co-pending U.S. Provisional Application No. ______ (attorney docket no. 6/088), entitled “Position Sensor And Controller For A MEMS Device And Incorporation Thereof Into An Optical Device”, filed Mar. 18, 2001 in the names of O'Hara et. al, which is commonly assigned to Integrated Micromachines, Inc., the assignee of the present invention. This application is fully incorporated by reference herein.

After a predetermined elapsed time in which positional data samplings are collected for mirror slew or dither path, such data are feed to the global control device 1. Feedback control may follow the system disclosed in the concurrently filed, co-pending U.S. Provisional Application No. 60/277,057 (attorney docket no. 1017/226), which had been fully incorporated by reference herein.

Output data 10 is any data tapped, taken, sensed, collected, or otherwise known, which indicates the state of optimization of the real process output 8. Generally the output data will be some known portion of the real process output thus allowing for a calculation of the real process output from the output data. In an OXC, output data is taken using a common optical tap placed in the power output of the device. Output data is routed to the global control device by typical opto-electrical connectors and converters. Once such output data is stored in the global control device it is combined with the stored initial command values, incoming data from the real time data collection device, and data taken at the end of the current system state change. All datasets can then be mapped in a multi-dataset mapping device (Step 6). The multi-dataset mapping device is a set of known desired processing algorithms, which operate on the datasets to produce certain functional outputs. Processing algorithms may be implemented in the form of system or machine readable software, or may be designed to operate as part of an integrated circuit. For particular sets of data, different processing or mapping algorithms will be more desirable. Typically one will chose the algorithm or function that most closely models or maps the real process. Such algorithms include, but are not limited to the least-squares method, iterative functions, Kalman filters, neural networking systems, fuzzy logic systems, and trial-and-error algorithms. For instance, when mapping incoming or collected real process data as a function of output data, it would be desirable to use a least-squares method of data mapping to “fit” data to a parabolic function, for example, thus making a peak estimate of the function easier to calculate then a Gaussian function, for example. In various technical systems different data maps will be more desirable that others, but generally the function, which produces the best peak, estimate value in the least amount of time should be used.

In order to accommodate the most efficient means of optimizing a given technical system, there is provided, in accordance with this invention, an evaluation function device 13. The purpose of this device to is to evaluate the outputs or data maps from a given number of processing algorithms, using a set of programmed or selected parameters, pick the output which will best yield a relevant peak process estimate, and send such outputs to the peak estimating device (Step 7). Conversely the evaluation function device may, for some systems, or in particular cases of a given system, use an optimization algorithm device 16 where in the simplex, or other trial-and-error algorithm, are used to find the peak value of the system (Step 10). Specifically, in cases where real process data was collected from non or less relevant regions around a particular initial peak estimate, or where random data sampling from around a particular initial peak estimate did not yield a sufficiently rich set of data points for processing in the peak estimating device, such data may be passed to a trial-and-error algorithm whereupon searching will commence for the optimal variable values. In most technical systems the evaluation function will involve a complex application of some compare and contract functions, or other appropriate functions to achieve the same objectives given the disclosure of the present invention herein. Typical factors to be compared and contrasted by an evaluation function are the condition of the data (or data matrix), and the signal to noise level of the system. In an OXC, it is often the case that collected data is sparse or non-uniform (as distributed over a Gaussian), or a high level of system noise is present and interferes substantially with the accuracy of functional output. While design or environmental control efforts can be made to minimize one or both factors, the evaluation function device will choose appropriate functional outputs when such adverse factors are nonetheless present.

In general, an evaluation function is not necessary to complete the optimization process as one or more functional outputs could be used independently or simultaneously to yield peak process estimates or search using a trial-and-error method without evaluating the likelihood of success, failure, or efficiency of such functional outputs. For some systems it may be advantageous to run parallel processing functions on all functional data outputs rather than evaluate for best cases, thus covering all basis in the system optimization.

The peak estimating device 19 accepts functional data from the evaluation function device, or directly from the multi-dataset mapping device in a case where evaluation functions are unnecessary or not desirable, and calculates a relevant peak process estimate (Step 8). The relevant peak process estimate refers to the peak or max of a function or map generated from real process data about the initial peak process estimate. This relevant peak process estimate should, and in most cases will yield the actual peak process values as new command values (Step 11), depending on the richness of sampled real process data and the ability of a given algorithm to process such data in real time to produce a functional output. In this case, new command values are sent to the variable elements and the system is optimized upon completion or settling of state change. No further iterations of the process are necessary at this point (Step 12). Alternatively, in cases where actual process peak values were not obtained on the first iteration, more iterations of the data collection and peak estimating process may be run until such time as the optimal values are reached. It may be the case, as in an OXC, that actual process peak values are only known by comparing such values to current output data. In such systems, unless the initial process peak estimate yields optimal output data upon system settling or final position, the process will need to iterate at least twice.

The hardware and/or software implementations of the optimization method and system disclosed herein may be embodied in a central system processor, multifunction processor such as the processor for overall control of the OXC, or application specific integrated circuits (ASICs), or any combination or subcombination of foregoing in a central, local, consolidated, or distributed configuration. The hardware and software may be implemented and integrated with the components to be controlled to optimize one or more of the system functions, such as implementing in ASICs in the optical switches in the OXC to optimize the optical coupling discussed in the illustrative embodiments discussed above.

While the present invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A method for optimizing a multivariable system, comprising the steps of:
a) providing initial real process command values to change initiate state of real process variable elements;
b) performing optimization based on said initial real process command values;
c) collecting real process data during said initial state change;
d) performing optimization based on said real process data;
d) determining a first dynamic peak value estimate using initial real process command values and collected real process data;
e) generating a revised set of real process command values using the first dynamic peak value estimate; and
f) providing said revised set of real process command values to real process variable elements.

2. A method for optimizing a multivariable system, comprising the steps of:
generating initial output peak value estimate for desired system state using nominal real process values stored in a global control device;
generating initial real process command values using said initial output peak value estimate;
delivering said initial real process command values to real process variable elements;
delivering said initial real process command values to an optimization algorithm device for performing an optimization routine;
activating said real process variable elements such that said real process variable elements undergo an initial state change corresponding to said initial real process command values;
collecting real process data during said initial state change and delivering said real process data to the optimization algorithm device for performing optimization;
introducing system changes within a predetermined tolerable range during said initial state change about said initial output peak value estimate;
collecting real process data during said initial state change and said introduced system changes;
mapping data sets from initial real process command values, collected real process data, and delivering said data sets to the optimization algorithm device.
